(19) United States
(12) Patent Application Publication
(10) Pub. No.: US 2015/0316778 A1
(43) Pub. Date: Nov. 5, 2015

(54) ANALOGUE PARALLAX BARRIER

(71) Applicant: Sharp Kabushiki Kaisha, Osaka (JP)

(72) Inventors: Nathan James SMITH, Oxford (GB); Alexandra BAUM, Taby (SE); Jonathan MATHER, Oxford (GB); Laura HUANG, Oxford (GB)

(21) Appl. No.: 14/650,060

(22) PCT Filed: Dec. 6, 2013
(86) PCT No.: PCT/JP2013/083403

§ 371 Date: Jun. 5, 2015

(30) Foreign Application Priority Data
Dec. 12, 2012 (GB) 1222365.7

(51) Int. Cl. G02B 27/22; G02B 27/00; G02F 1/1343

(52) U.S. Cl. CPC G02B 27/2214; G02F 1/134309; G02F 1/13439; G02B 27/0093

(57) ABSTRACT

An optical modulation device has an electro-optical cell in which first and second electrodes (3a, 3b) are disposed on a first substrate (1), in electrical contact with a resistive layer (2) disposed on the first substrate. A third electrode (3c) is disposed on a second substrate (5), and an electro-optic material (4) is disposed between the first substrate and the second substrate. When different voltages (V0, V1) are applied to the first and second electrodes (3a, 3b) in a first mode of operation, a voltage gradient is set up along the resistive layer (2). By applying an intermediate voltage (V_{sig}) to the third electrode (3c), it is possible to define at least a first region (6a) in the electro-optical cell in which the voltage applied across the electro-optical material is lower than a switching threshold voltage and a second region (6b) in the electro-optical cell in which the voltage applied across the electro-optical material is greater than the switching threshold voltage. The position and width of the first region (6a) are controllable independently from one another; furthermore, the position and width of the first region (6a) are continuously variable, since they are defined by the voltages applied to the first, second and third electrodes.

### TECHNICAL FIELD

This invention relates to switchable imaging optics for use in 3D autostereoscopic (no glasses) devices and devices where a directed backlight would be desirable.

Priority is claimed on UK Patent Application No. 1222365.7, filed on Dec. 12, 2012, the content of which is incorporated herein by reference.

### BACKGROUND ART

For many years people have been trying to create better autostereoscopic 3D displays, and this invention provides a further advance in this field. An autostereoscopic display is a display that gives stereoscopic depth without the user needing to wear glasses. This is accomplished by projecting a different image to each eye. An autostereoscopic 3D display can be realised by using parallax optic technology such as a parallax barrier or lenticular lenses.

The design and operation of parallax barrier technology for viewing 3D images is well described in a paper from the University of Tokushima Japan (“Optimum parameters and viewing areas of stereoscopic full colour LED display using parallax barrier”, Hirotsugu Yamamoto et al., IEICE trans electron, vol E83-c no 10 Oct. 2000) (Non-Patent Document 1).

FIG. 1 shows the basic design and operation of parallax barrier technology for use in conjunction with an image display for creating a 3D display. The images for the left eye and right eye are interlaced on alternate columns of pixels of the image display. The slits in the parallax barrier allow the viewer to see only left image pixels from the position of their left eye and right image pixels from the position of their right eye.

The parallax barrier illustrated in FIG. 1 can be configured to provide a high quality 3D mode. However, many applications exist whereby a display is also required to operate in a high quality 2D mode. Using the technology illustrated in FIG. 1 would yield a 2D image with half the native resolution of the image display—this is highly undesirable. For the image display to show an image with 100% native resolution in the 2D mode, the parallax optics (parallax barrier or lenticular) must be switchable between a first mode that provides substantially no imaging function (2D mode) to a second mode of operation that provides an imaging function (3D mode). An example of a switchable parallax barrier technology is disclosed in U.S. Pat. No. 7,813,042B2 (Patent Document 1).

A fixed parallax barrier has the disadvantage that the viewer observes a stereoscopic image only in strict viewing zones. Outside these zones, pixel information intended for the left eye may reach the right eye and vice versa. By tracking the positions of the eyes, the parameters of the barrier can be changed to allow stereoscopic viewing with greater head freedom. EP00833183A1 (Patent Document 2) describes the use of an array of electrodes to create a switchable barrier of arbitrary barrier pattern from a liquid crystal layer. GB02415849A1 (Patent Document 3) also discloses a method of making a controllable barrier by the introduction of varying thicknesses of a material with a known dielectric permittivity, thereby changing threshold switching voltages. However, the disadvantage of the above two methods is that the barriers produced are arbitrary only up to a discrete distance governed by (respectively) the separation of the electrodes in the array and the lateral size of the dielectric material blocks.

The use of a resistive layer between electrodes to vary the potential difference across the LC layer in a continuous way has been investigated by Hands et al. (“Adaptive modally addressed liquid crystal lenses”, Proc SPIE 5518, 136, 2004) (Non-Patent Document 2) where the smoothly varying refractive index has been used to create a variable focal length spherical lens. The properties of such lenses according to the applied signal were studied by Naumov et al. (“Liquid crystal adaptive lenses with modal control”, Optics Letters, Vol 23 No 13, 1 Jul. 1998 (Non-Patent Document 3) and “Control optimisation of spherical modal liquid crystal lenses”, Optics Express, Vol 4 No 9, 26 Apr. 1999 (Non-Patent Document 4)).

The use of a resistive layer between electrodes in a liquid crystal display device is proposed in WO2005/015300A1 (Patent Document 4), where the resistive layer is used only to control the direction of the electric field during LC switching in order to avoid the production of disclination lines in the LC layer. After switching a uniform field is maintained. The use of a resistive layer in a ferroelectric liquid crystal device is described in U.S. Pat. No. 4,815,823 (Patent Document 5), where the bistable switching properties of the LC are used to perform spatial light modulation, of a pixellated display. The use of a resistive layer in order to spatially alter the transmission function of a device is disclosed in EP1484634A1 (Patent Document 6), where a “curtain effect” is produced over a pane of glass or other substrate.

The use of a resistive layer between electrodes in a single pixel display device is proposed in U.S. Pat. No. 4,392,718A (Patent Document 7), where the two electrodes are applied with alternating voltages and the relative phase of the voltages determines the spatial transmission function of the display. The use of a resistive layer between electrodes in a single pixel display device is proposed in U.S. Pat. No. 4,106,858A (Patent Document 8), where one electrode is applied with an alternating voltage of frequency below a threshold relaxation frequency and the other with an alternating voltage of frequency above this threshold. The voltage amplitude decays along the resistive layer so that the two frequencies are of different importance in different regions of the display, producing two regions of LC with different optical characteristics. The use of a resistive layer in a single pixel display is also discussed in U.S. Pat. No. 4,139,278 (Patent Document 9) and U.S. Pat. No. 3,675,988 (Patent Document 10).

The use of a resistive layer in conjunction with an annular electrode in order to create an iris or circular stop is discussed in U.S. Pat. No. 3,741,629A (Patent Document 11). U.S. Pat. No. 4,112,361A (Patent Document 12) proposes a method of producing a decibel meter using a LC layer and a resistive layer with a spatially varying resistance. The resistance changes exponentially with distance via an appropriate variation in material resistivity, layer thickness or layer width.

The use of a head tracking system that is operatively coupled to a switchable optical device in order that light from a display is directed towards a user in order to reduce the power consumption of a display system is proposed in US2009/0213147 (Patent Document 13).

### CITATION LIST

### Patent Document

[Patent Document 1] U.S. Pat. No. 7,813,042B2

[Patent Document 2] EP00833183A1

[Patent Document 3] GB02415849A1

[Patent Document 4] WO2005/015300A1

[Patent Document 5] U.S. Pat. No. 4,815,823

[Patent Document 6] EP1484634A1

[Patent Document 7] U.S. Pat. No. 4,392,718A

[Patent Document 8] U.S. Pat. No. 4,106,858A

[Patent Document 9] U.S. Pat. No. 4,139,278

[Patent Document 10] U.S. Pat. No. 3,675,988

[Patent Document 11] U.S. Pat. No. 3,741,629A

[Patent Document 12] U.S. Pat. No. 4,112,361A

[Patent Document 13] US 2009/0213147

### Non-Patent Document

[Non-Patent Document 1] a paper from the University of Tokushima Japan, “Optimum parameters and viewing areas of stereoscopic full colour LED display using parallax barrier”, Hirotsugu Yamamoto et al., IEICE trans electron, vol E83-c no 10 Oct. 2000

[Non-Patent Document 2] Hands et al., “Adaptive modally addressed liquid crystal lenses”, Proc SPIE 5518, 136, 2004

[Non-Patent Document 3] Naumov et al., “Liquid crystal adaptive lenses with modal control”, Optics Letters, Vol 23 No 13, 1 Jul. 1998

[Non-Patent Document 4] Naumov et al., “Control optimisation of spherical modal liquid crystal lenses”, Optics Express, Vol 4 No 9, 26 Apr. 1999

### DISCLOSURE OF THE INVENTION

A first aspect of the invention provides an optical modulation device comprising an electro-optical cell and a controller, the electro-optical cell having: a first substrate; a first electrode and a second electrode disposed on the first substrate, the first electrode being spaced from the second electrode in a direction parallel to the plane of the first substrate; a resistive layer disposed on the first substrate and electrically connected to the first electrode and to the second electrode; a second substrate spaced from the first substrate; a third electrode disposed on the second substrate; and an electro-optical material disposed between the first substrate and the second substrate. The display is operable in at least a first mode in which the controller is adapted to apply a first voltage to the first electrode, to apply a second voltage to the second electrode and to apply a third voltage to the third electrode, the first, second and third voltages being selected to define at least a first region in the electro-optical cell in which the voltage applied across the electro-optical material is lower than a switching threshold voltage of the electro-optical material and a second region in the electro-optical cell in which the voltage applied across the electro-optical material is greater than the switching threshold voltage, the third voltage being intermediate the first voltage and the second voltage whereby the position and width of the first region are controllable independently from one another.

By “width” is meant the extent in a direction extending from the first electrode to the second electrode.

As is known, when no voltage is applied across the electro-optical material of a display the electro-optical material adopts a zero-voltage state, also known as the “unswitched state”. As the voltage applied across the electro-optical material is increased, the electro-optical material initially remains in the unswitched state. However, when the voltage applied across the electro-optical material reaches a switching threshold voltage (for example, the liquid crystal threshold voltage in the case of a liquid crystal electro-optic material), the electro-optical material starts to be switched out of the zero-voltage or unswitched state, leading to a change in the transmissivity of the display. The LC switching threshold voltage of a monostable LC mode can be between ˜0.5V and ˜2.5V depending upon the LC mode, although the switching threshold of some bistable LC modes may be higher. A typical switching threshold voltage for a TN LC mode is ˜1V.

The principle of the invention is that the voltage on the first substrate is not constant, but that the voltage on the first substrate depends on the lateral position between the first electrode and the second electrode since the different voltages applied to the first and second electrodes result in a voltage gradient across the resistive layer. As a result, there is a point somewhere between the first electrode and the second electrode where the voltage of the resistive layer is equal to the voltage applied to the third electrode on the opposing (second) substrate, so that there is no net voltage across the electro-optical material at this point. Accordingly, a region is defined in which the voltage applied across the electro-optical material is lower than a switching threshold voltage of the electro-optical material, and the electro-optical material in this region stays in its zero-voltage state. Outside this region the voltage applied across the electro-optical material is greater than the switching threshold voltage and the state of the electro-optical material is therefore switched from its zero-voltage state, leading to a different transmissivity of the electro-optical cell. For example, if the electro-optical cell is arranged to be normally white, the region of the electro-optical cell in which the voltage is lower than the switching threshold voltage will remain white (ie, will remain maximally transmissive), whereas outside this region the transmissivity of the electro-optical cell will be reduced (and preferably is maximally attenuating)—so that the region of the electro-optical cell in which the voltage is lower than the switching threshold voltage provides one or more transmissive “apertures”, surrounded/separated by a (substantially) non-transmissive region.

The width of the region in which the voltage is lower than the switching threshold voltage is defined by the voltage gradient between the first electrode and second electrode, ie is defined by the first and second voltages but is independent of the third voltage, whereas the centre of this region is defined as the place where the voltage of the resistive layer is equal to the third voltage. The position and the width of the region in which the voltage is lower than the switching threshold voltage can therefore be controlled independently of one another. Furthermore, the position and width of the region in which the voltage is lower than the switching threshold voltage are each continuously variable, and any desired position and width may be obtained by application of suitable first, second and third voltages by the controller. The invention can thus be considered as providing “analogue” control of the position and width of the transmissive apertures in that the position and width are each continuously variable—in contrast to the prior art in which the position and width of the transmissive apertures can adopt only certain predefined values.

Alternatively, a uniformly transmissive state may be obtained by setting the first, second and third voltages so that the electro-optic material is in a single state over the entire cell—for example, if the first, second and third voltages are all set to zero the electro-optical material remains in its zero-voltage state over the entire electro-optical cell so that the electro-optical cell has uniform transmissivity over its entire area (being maximally transmissive for a normally white mode or maximally attenuating for a normally black mode).

The first electrode may include an array of first conductive strips and the second electrode may include an array of second conductive strips. The first conductive strips may be interdigitated with the second conductive strips. In this embodiment a region of the electro-optical cell in which the voltage is lower than the switching threshold voltage may be obtained between pair of a first strip and an adjacent second strip. If, for example, the electro-optical cell is arranged to be normally white, this embodiment allows a plurality of transmissive apertures, separated by maximally attenuating regions, to be obtained—so, for example a parallax element aperture array may be obtained. Moreover, the invention may provide a disableable parallax element aperture array since, as noted, a uniformly transmissive state may be obtained by setting the first, second and third voltages so that the electro-optic material is in a single state over the entire cell.

The second conductive strips may be unequally spaced between the first strips. By arranging the strips so that the spacing between a first strip and one of its two neighbouring second strips is small, it is possible to suppress (for example by setting up fringing fields) generation of a region in which the electro-optic material is in its zero-voltage state while still obtaining a region in which the electro-optic material is in its zero-voltage state between the first strip and the other of its neighbouring second strips. As a result, the pitch of the regions in which the electro-optic material is in its zero-voltage state is equal to the pitch of the first/second strips (the pitch of the first strips is equal to the pitch of the second strips). It is therefore possible to provide a reconfigurable parallax barrier aperture array in which the position and width of the apertures are continuously variable and can be controlled independently from one another without affecting the pitch of the apertures. Moreover, as noted above, the parallax barrier aperture array may be disabled by setting the voltages to give a uniform transmissivity over the electro-optic cell.

The device may further comprise a fourth electrode disposed on the second substrate, the fourth electrode being spaced from the third electrode in a direction parallel to the plane of the second substrate.

The third electrode may include an array of third conductive strips and the fourth electrode may include an array of fourth conductive strips, the third conductive strips being interdigitated with the fourth conductive strips.

The device may further include a second resistive layer disposed on the second substrate and electrically connected to the third electrode and to the fourth electrode.

The fourth conductive strips may be unequally spaced between the third strips.

The first resistive layer may be a patterned resistive layer comprising a plurality of resistive strips electrically isolated from one another, each resistive strip being electrically connected to a respective first conductive strip and a respective second conductive strip. Additionally or alternatively, the second resistive layer may be a patterned resistive layer comprising a plurality of resistive strips electrically isolated from one another, each resistive strip being electrically connected to a respective third conductive strip and a respective fourth conductive strip. This can prevent an electrical shortcut between two conductive strips.

The first conductive strips may be arranged in two or more groups, each group including at least one first conductive strip, and each group of first conductive strips being electrically isolated from the or each other group of first conductive strips. This enables the controller to address each group of first conductive strips independently of each other group of first conductive strips, thereby providing greater freedom in defining transmissive and non-transmissive regions in the electro-optic cell.

Each first conductive strip may be electrically isolated from each other first conductive strip. This enables the controller to address each first conductive strip independently of each other first conductive strip, thereby providing even greater freedom in defining transmissive and non-transmissive regions in the electro-optic cell.

The second conductive strips may be arranged in two or more groups, each group including at least one second conductive strip, and each group of second conductive strips being electrically isolated from the or each other group of second conductive strips.

Each second conductive strip may be electrically isolated from each other second conductive strip.

The voltage applied across the electro-optical material in the second region may be equal to or greater than a saturation voltage. This puts the electro-optical material in the second region in its fully switched state, and provides the greatest difference in transmissivity between the first region and the second region.

As described above, an electro-optical material starts to be switched out of its zero-voltage state when the applied voltage across the electro-optical material reaches or exceeds the threshold voltage. As the applied voltage increases beyond the threshold voltage the electro-optical material will adopt a different orientation until it eventually adopts, or tends towards, a final orientation after which a further increase in the magnitude of the applied voltage produces substantially no further change in orientation of the electro-optical material. The final orientation is usually considered as having been obtained when the voltage across the electro-optical material is equal to or greater than the “saturation voltage” of the electro-optical material. In the example of a liquid crystal electro-optic material, the LC saturation voltage can be between ˜2V and ˜10V and is often defined as the point at which the transmission is at ˜95% of the transmission that would occur (for a normally black display) if an infinite voltage was to be applied to the LC material. A state in which the voltage applied across the electro-optical material is equal to or greater than the saturation voltage is referred to as a “fully-switched state”. The term “partially switched state” refers to a state in which the magnitude of the voltage applied across the electro-optical material is large enough to cause some change in orientation of the electro-optical material so that the electro-optical material is no longer in its unswitched state, but in which the magnitude of the voltage applied across the electro-optical material is not large enough to cause the electro-optical material to adopt its fully switched state.

For any LC mode that does not display a hysteretic switching characteristic, the voltage required to achieve the “fully-switched state” (i.e. saturation voltage) is greater than the threshold voltage. For any LC mode that does not display a hysteretic switching characteristic, the voltage required to achieve the “partially switched state” is between the threshold voltage and the saturation voltage.

The electro-optical cell may be a liquid crystal cell.

A second aspect of the invention provides a display comprising an image display layer and an optical modulation device of the first aspect disposed in the path of light through the image display layer. By driving the optical modulation device to define a parallax barrier aperture array the display may be operated in a directional display mode such as an autostereoscopic display mode.

The optical modulation device may be disposed between the image display layer and an observer. In this embodiment the image display layer may be a transmissive display layer (such as a liquid crystal layer) illuminated by a backlight or it may be an emissive display layer (such as an OLED layer).

The display may further comprise a backlight, and the optical modulation device may be disposed between the backlight and the image display layer.

The controller may be operable in a first mode to define a parallax barrier aperture array in the optical modulation device and in a second mode different from the first mode. For example, the second display mode may be a non-directional display mode, in which the optical modulation device is driven to have a substantially uniform transmissivity (and preferably to be maximally transmissive) over its entire area.

Additionally or alternatively, the controller may operable in a first mode to define a first parallax barrier aperture array in the optical modulation device and may be operable in a second mode to define a second parallax barrier aperture array in the optical modulation device mode, the second parallax barrier aperture array being different from the first parallax barrier aperture array. The parallax barrier may be reconfigured between modes, by varying the position and/or width of the apertures, for example to compensate for movement of an observer.

The controller may receive an input signal from an observer tracking system. This enables the controller to reconfigure the parallax barrier to compensate for movement of an observer.

The head freedom allowed by autostereoscopic devices (the region in space where a good 3D image can be observed) can be significantly improved by tracking the position of the viewer's head and ensuring that the images intended for the viewer's left and right eyes are directed appropriately. This can be performed by using a fixed barrier and altering the pixel data as required or by using a barrier whose aperture pattern can be adjusted or by incorporating both in combination. Barriers which may only be adjusted in a discrete fashion (as described in the prior art) are disadvantageous for high quality 3D imaging because they suffer from brightness non-uniformity across the screen as different portions of the display mask can be observed through the parallax barrier slit.

Improved display efficiency will reduce power consumption and also increase the battery life of mobile devices. For a single user, much light is wasted by being emitted at wide angles; a tracked directional display may be more efficient.

According to a first aspect, the invention comprises a first substrate, which has a first transparent conductive electrode connected to a second transparent conductive electrode via a transparent resistive layer. A second substrate has a third transparent electrode. The first and second substrates are separated by a predetermined distance and encase a liquid crystal (LC) layer to form a cell. The LC is switchable between a first mode that does not perform an imaging function (the LC is not switched) and a second mode that performs an imaging function. In the second mode, the LC is switched to define an array of apertures which provide an imaging function. Application of a voltage between the first and second electrodes creates a voltage gradient across the resistive layer. This, in conjunction with a potential applied to the third electrode, the LC and polarising elements, produces a first substantially transmissive region (hereafter aperture) and a second substantially non-transmissive (hereafter opaque) region. Control of the voltages on the first, second and third electrodes enables both the size and the position of the aperture to be controlled in an analogue fashion.

According to a further aspect of the invention, the first and second electrodes of the first substrate consist of multiple parallel strips extending in a first direction. Successive strips may be addressed with one of two voltage levels by the use of an interdigitated pattern. A voltage gradient is thus generated between successive strips, which cooperates with the third electrode, the LC and polarising elements to produce multiple apertures extending in the first direction and separated by opaque regions. The positions and sizes of the apertures between the conductive strips may be controlled in an analogue fashion by the control of the voltages applied to the first, second and third conductive electrodes.

According to a further aspect of the invention, the conductive strips of the first and second electrodes are unequally spaced such that the voltage ramps between pairs of electrodes have the same gradient (both magnitude and direction). This produces multiple apertures extending in the first direction whose positions and widths may be controlled in an analogue fashion and where the separation of the apertures is constant. This type of barrier may be used in conjunction with an image display to enable a head tracked autostereoscopic 3D display.

According to a further aspect of the invention, the second substrate may have an additional (fourth) transparent electrode. The third and fourth electrodes may be patterned to produce conductive strips extending in the first direction. Successive strips may be addressed with one of at least two voltages by the use of an interdigitated electrode pattern. Control of the voltages applied to the first, second, third and fourth electrodes produces multiple apertures extending in the first direction whose positions and widths may be controlled in an analogue fashion and where the separation of the apertures is constant. This type of barrier may be used in conjunction with an image display to enable a head tracked autostereoscopic 3D display.

According to a further aspect of the invention, the first substrate has a transparent and resistive layer and the conductive strips of the first and second electrodes are unequally spaced and interdigitated. Similarly, the second substrate has a transparent and resistive layer and the conductive strips of the third and fourth electrodes are unequally spaced and interdigitated. The conductive strips of the first substrate are offset from those of the second substrate. A voltage ramp may be applied between the conductive strips of the first and second electrodes or between the conductive strips of the third and fourth electrodes which allows for a continuous analogue moving barrier suitable for head tracked 3D autostereoscopic displays with wide head freedom.

According to a further aspect of the invention, the resistive layer of either or both substrate(s) may be patterned in order to control current flow and prevent short circuit.

According to a further aspect of the invention, either or both substrate(s) may have more than two electrodes: such that the conductive strips along the device may be addressed individually or in multiple groups. This allows the separation(s) of the apertures to be controlled across the barrier and may be used in order to improve the head freedom of a 3D display in the direction parallel to the screen normal (hereafter the z direction).

According to a further aspect of the invention, the inclusion of a polarisation sensitive reflector may be used to recycle light that would otherwise be blocked so that the device is suitable for an improved efficiency tracked backlight display.

### BRIEF DESCRIPTION OF THE DRAWINGS

FIG. 1: Prior art

FIG. 2: Movable aperture

FIG. 3: Slit array

FIG. 4: Slit array of constant separation

FIG. 5: Barrier with image manipulation

FIG. 6: Slit array of constant separation

FIG. 7: Continuous moving barrier

FIG. 8: Patterned resistive layer

FIG. 9: Pitch control

FIG. 10: Active pitch correction

FIG. 11: System block diagram for 3D application

FIG. 12: Directional display

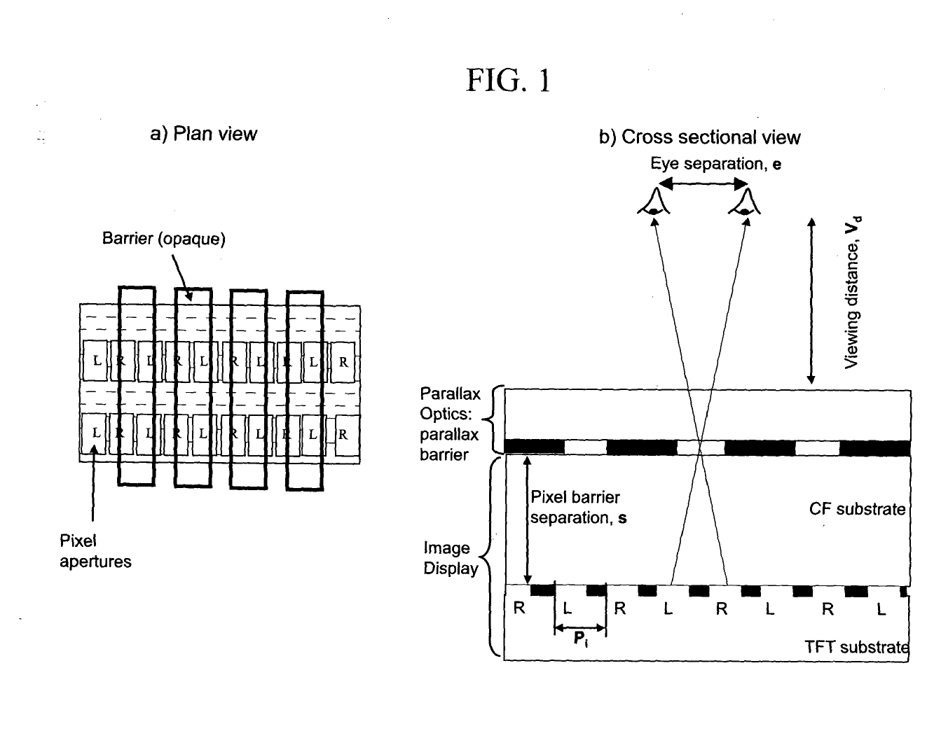

### BEST MODE FOR CARRYING OUT THE INVENTION

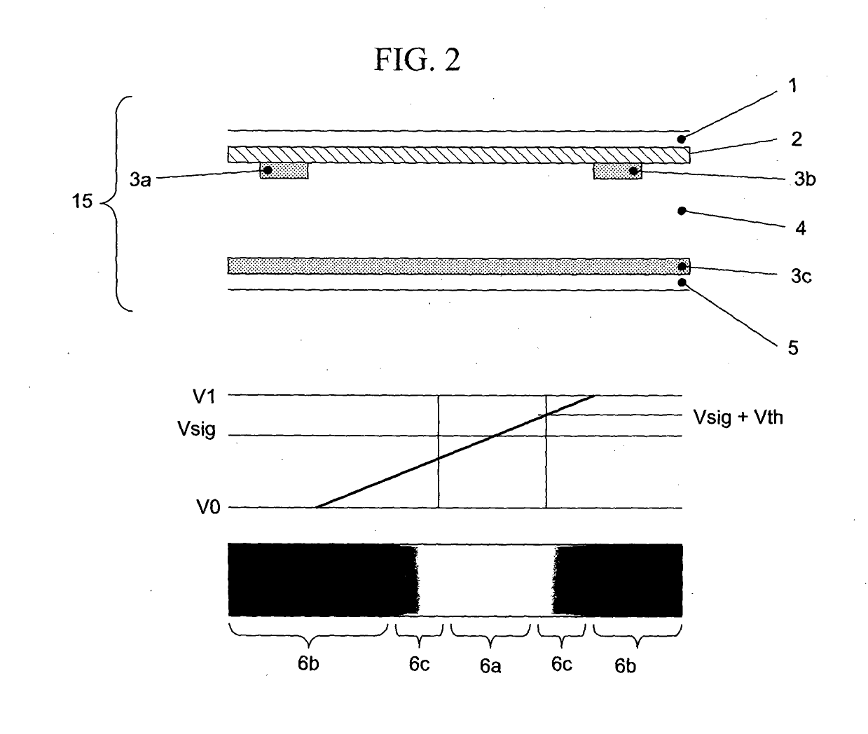

With reference to FIG. 2, an optical modulation device 15 is comprised of a first substrate 1 coated with a transparent resistive layer 2 and first 3a and second 3b electrodes, both conductive and transparent. The conductive electrodes 3a, 3b may be situated on top of the resistive layer 2, as shown in the diagram, or they may be situated between substrate 1 and the resistive layer 2. The resistive layer 2 may be but is not limited to indium gallium zinc oxide (IGZO) or Poly(3,4-ethylenedioxythiophene) (PEDOT) and may be applied via vacuum deposition, spin coating or another method appropriate for the material used. The conductive electrodes 3a, 3b may be indium tin oxide (ITO) and may be patterned. A LC alignment layer (not shown) is coated on top of the electrodes 3a, 3b and the resistive layer 2. The second substrate 5 is coated with transparent conductor 3c (a third electrode) and a LC alignment layer (not shown). The two substrates are assembled together in the orientations shown to form a cell 15 and are separated by a fixed amount by, for example, spacer beads. A liquid crystal layer 4 (or a layer of another electro-optical material) is encapsulated by the first and second substrates to form a liquid crystal (or electro-optical) cell. (The invention will be primarily described with reference to embodiments in which the electro-optical material is a liquid crystal material.) A thin cell may be desirable for a faster switching speed, but the spacing may be chosen to optimise the device for its intended application. The LC alignment layers on the first and second substrates may be processed and orientated with respect to each other to yield a LC mode that may be a Twisted Nematic (TN), Vertically Aligned Nematic (VAN), Electrically Controlled Birefringence (ECB), Super Twisted Nematic (STN) or Optically Compensated Birefringence (OCB). Polarising elements (not shown) are used on the outer surfaces of the device and may be orientated such to enable a normally white (NW) mode or a Normally Black (NB) mode. The normally white mode has the advantage that the device consumes no power when it is not performing an imaging function and will be assumed for the ensuing discussion.

The optical modulation device further includes a controller (not shown in FIG. 2) for applying voltages to the first, second and third electrodes. The device is operable in at least one mode of operation in which the first 3a and second 3b electrodes are separately addressed and are at first and second voltages V0 and V1 respectively such that a voltage ramp forms between them along the resistive layer 2. The third electrode 3c is held at a third voltage, in this example a signal voltage Vsig. In this mode the first, second and third voltages are selected to define at least a first region in the liquid crystal layer in which the voltage applied across the liquid crystal layer is lower than a threshold switching voltage and a second region in the liquid crystal layer in which the voltage applied across the liquid crystal layer is greater than the threshold switching voltage. For a liquid crystal layer configured in a normally white mode, an aperture 6a will form where the voltage across the cell is less than the threshold switching voltage Vth for the LC mode and an opaque region 6b will form where the voltage across the cell is substantially more than Vth (i.e. equal to or above a saturation voltage Vsat of the liquid crystal). The value of Vsig will control the position of the aperture between the electrodes and the voltage gradient will control the aperture width. By setting the third voltage intermediate the first voltage and the second voltage the position and width of the unswitched region of the liquid crystal layer are controllable independently from one another. Both position and width can be controlled in a continuous (analogue) fashion.

The boundary between the aperture 6a and the opaque 6b regions may not be well defined; rather, the aperture edge may extend over a region 6c where light transmittance is partial (the aperture edge is soft). In this region, the voltage is above the threshold voltage Vth but below the saturation voltage Vsat. A LC mode with a relatively wide drive voltage range between the transmissive state and the opaque state will produce a soft edge aperture (i.e. a relatively large transition region 6c between the aperture 6a and opaque 6b regions), whereas a LC mode with a relatively narrow drive voltage range between the transmissive state and the opaque state will produce a hard edge aperture (i.e. a relatively small transition region 6c between the aperture 6a and opaque 6b regions). Appropriate selection of the LC mode and also control of the voltage gradient along the resistive layer 2 both allow control of the width of the partially transmissive region 6c.

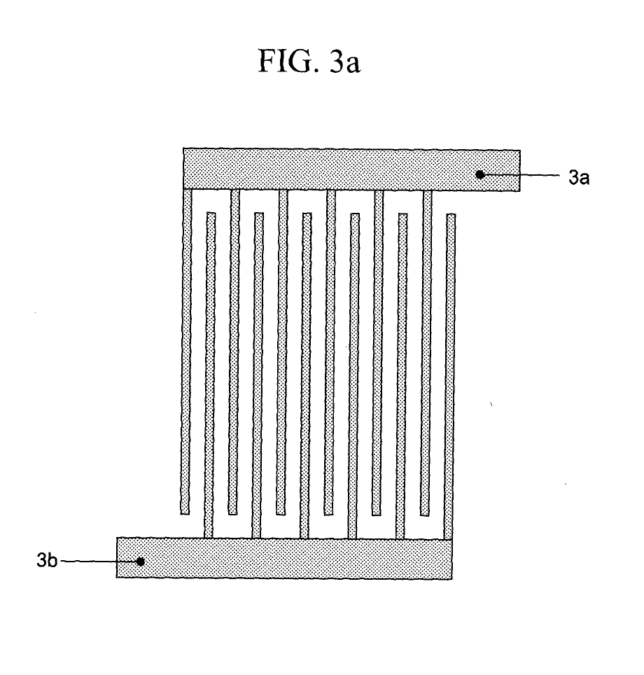

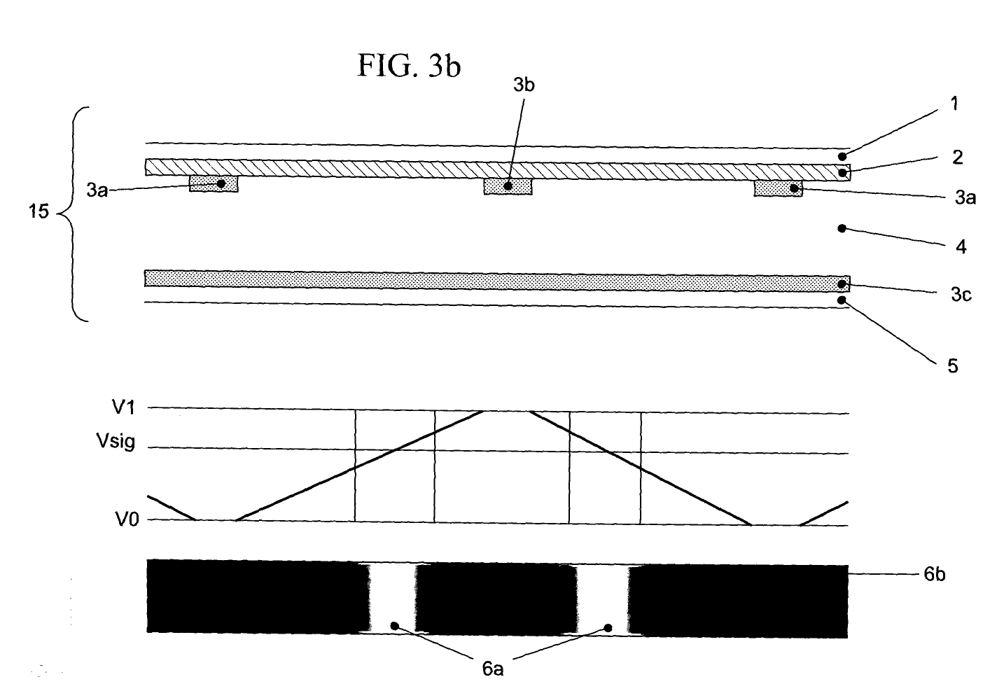

With reference to FIG. 3 and in accordance with a second aspect of the invention, the first 3a and second 3b electrodes may be patterned into strips extending in a first direction and interdigitated (FIG. 3a) so as to create a voltage ramp between successive strips (FIG. 3b). The application of Vsig to the third 3c electrode will then produce an array of apertures 6a extending in the first direction whose positions and widths may be controlled in an analogue fashion by the correct selection of voltages.

For the embodiment outlined in FIG. 3, the direction of the voltage gradient alternates between positive and negative with each successive conductive strip of the first 3a and second 3b electrodes. If the value of Vsig is raised the apertures will move towards the nearest electrode at the V1 voltage level. The separation between apertures is not constant but approximately alternates between two values, (2d-x) and x, where d is the separation of successive conductive electrode strips and x is an arbitrary distance which can be controlled in an analogue fashion by the appropriate selection of the applied voltages.

The optical modulation device 15 may be used in conjunction with an image display layer. For example, a display may be obtained by providing an optical modulation device of the invention in the path of light through an image display layer. The image display layer may be comprised in a display such as a Liquid Crystal Display (LCD) or Organic Light Emitting Display (OLED) etc. The device is operable at least in a first mode of operation, in which the optical device 15 creates a periodic array of apertures that perform an imaging function for said image display. The imaging function may enable a 3D autostereoscopic display system, as will be exemplified in the following two embodiments.

The optical modulation device 15 may also be operable in a second mode which is different to the first mode. In one embodiment, the optical device 15 does not perform an imaging function in the second mode. In another embodiment, in the second mode the optical modulation device generates a second periodic array of apertures that perform an imaging function, but with the second periodic array of apertures being different to the period array of apertures generated in the first mode. For example, the second periodic array of apertures generated in the second mode may have the same aperture pitch and aperture width as, but may have apertures at different positions to, the periodic array of apertures in the first mode (so that the array of apertures in the second mode corresponds to a translation of the array of apertures in the first mode), for example to compensate for movement of the observer.

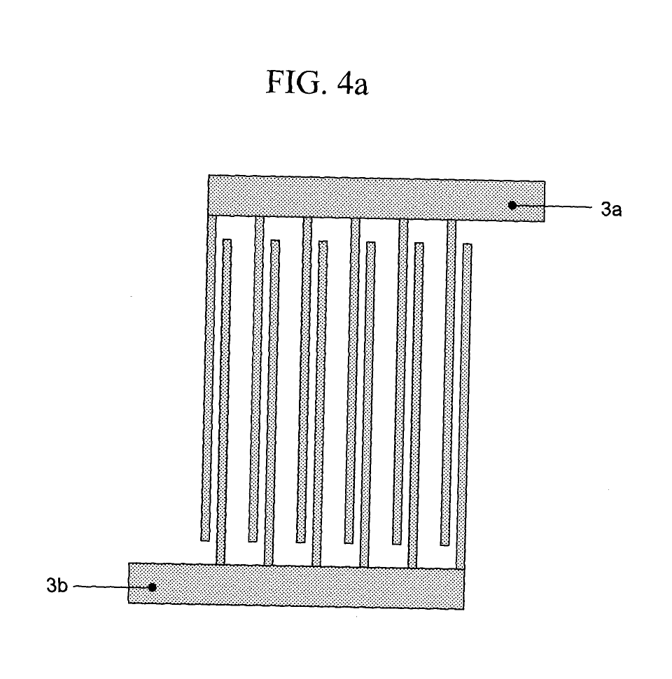

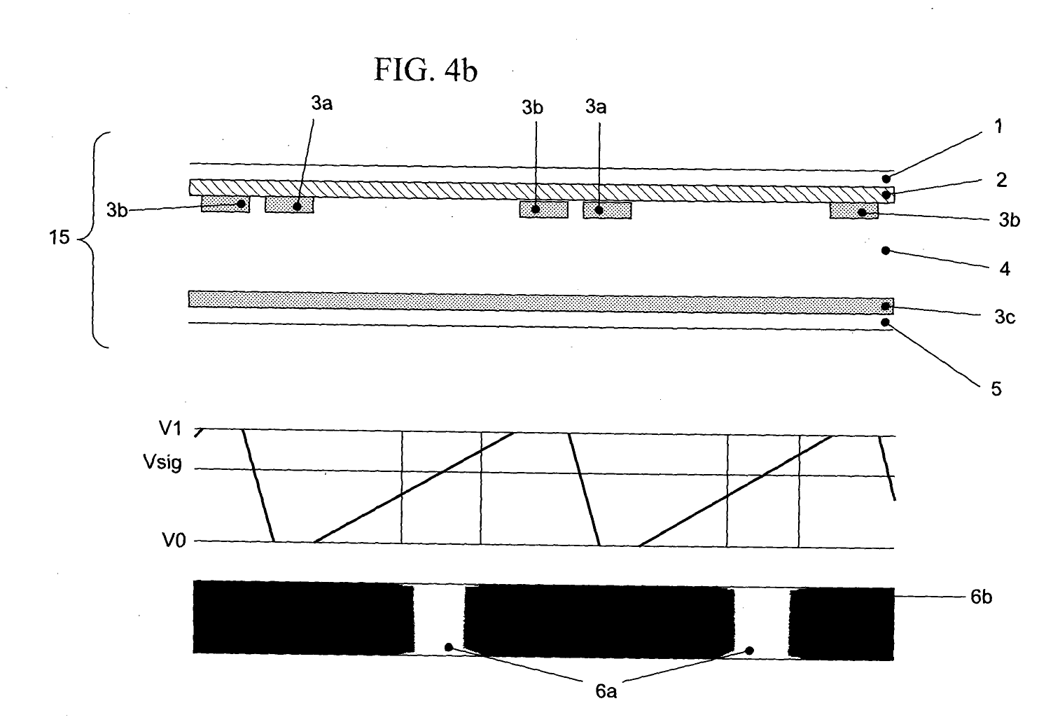

With reference to FIG. 4 and in accordance with a further aspect of the invention, the conductive strips of the first 3a and second 3b electrodes may be unevenly spaced (FIG. 4a) such that the gradient of the voltage ramp between successive pairs of electrodes is the same. This allows the apertures in the array to be evenly spaced independently of their position between the electrode pairs and independently of their width. The electrodes in each pair are closely spaced so that their fringing field between them switches the LC molecules into a substantially opaque mode (in the case of a normally white display) and one aperture is seen per electrode pair (FIG. 4b). This produces a parallax barrier which may be used for head tracked 3D autostereoscopic displays.

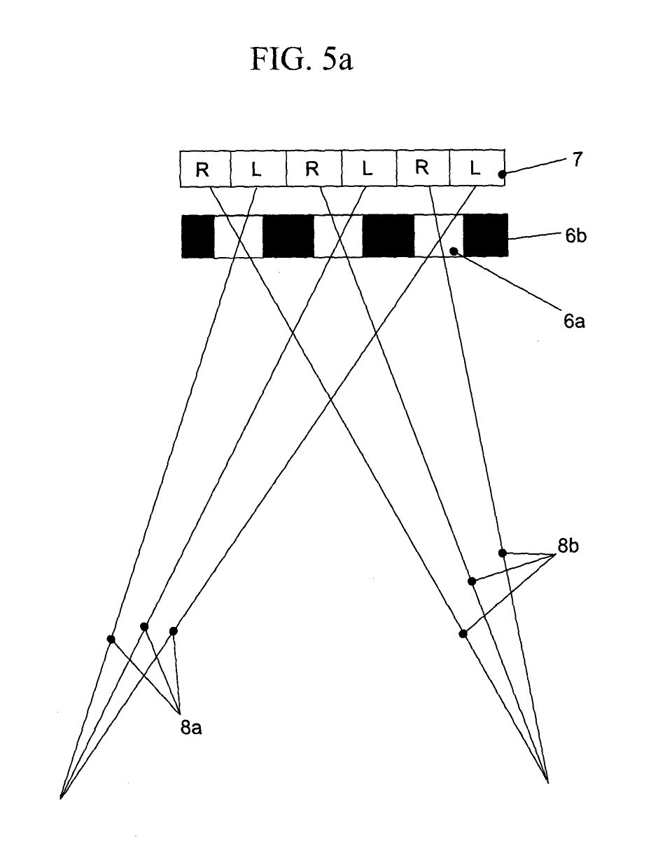

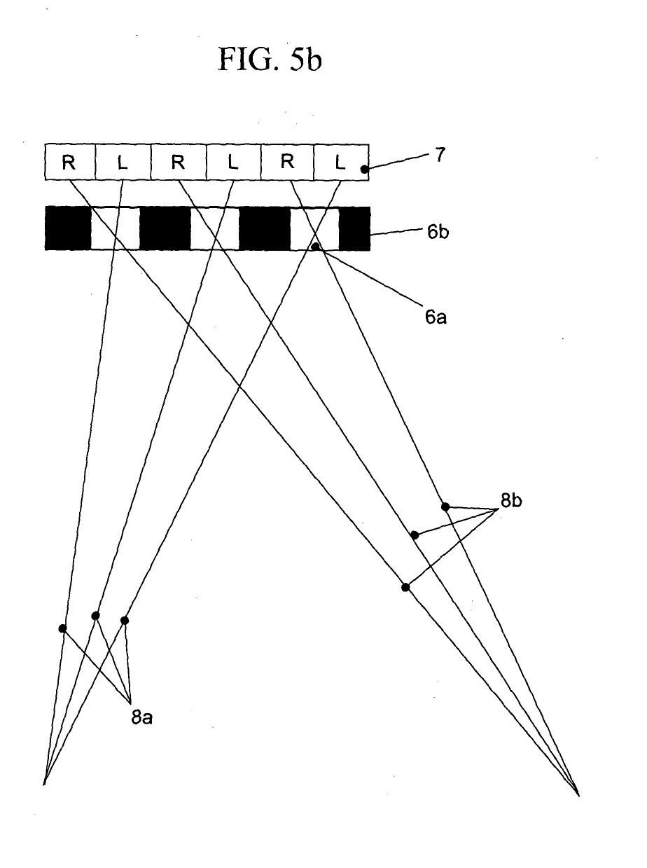

The range of motion of an aperture 6a is limited by the strips of the conductive electrodes which form the ramp 3a, 3b. This limits the transverse head freedom (head freedom perpendicular to the z direction). However, transverse head freedom may be improved by incorporating some image manipulation into the 3D display system. With reference to FIG. 5a, the pixels of the image display 7 may be addressed with information for the left eye (L) or information for the right eye (R). The barrier is composed of apertures 6a and opaque regions 6b as appropriate for a good 3D effect (lines of gaze 8a from the left eye reach left pixels and lines of gaze 8b from the right eye reach right pixels). If the position of the eyes changes, FIG. 5b, the positions of the apertures 6a may change to compensate and maintain a good 3D effect. If the apertures 6a reach the conductive strips then a good 3D effect may be maintained by swapping left pixel information for right pixel information and vice versa in conjunction with a shift in the aperture position as in FIG. 5c. The apertures are then no longer at the limit of their transverse positions and the 3D experience is maintained. This process thus allows a greater head freedom in the transverse direction.

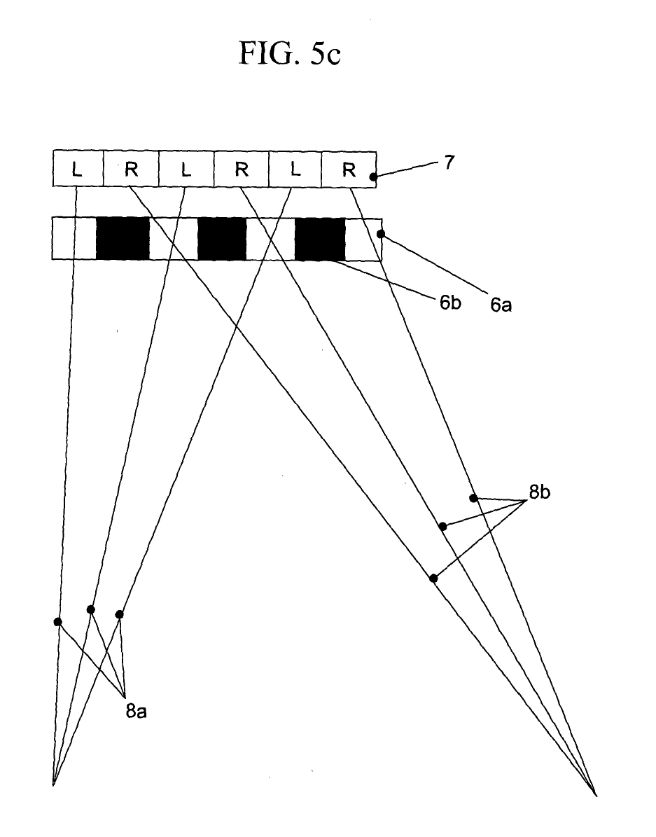

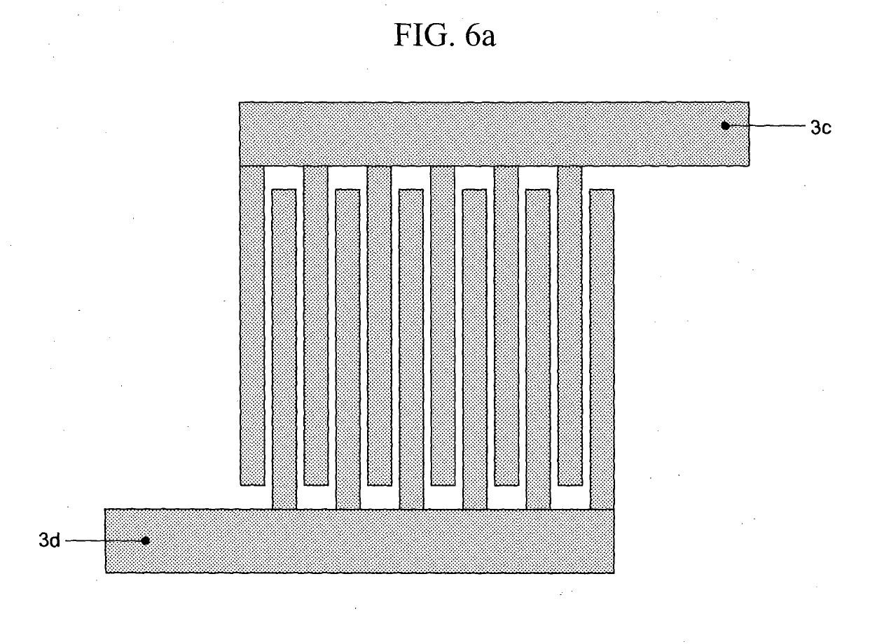

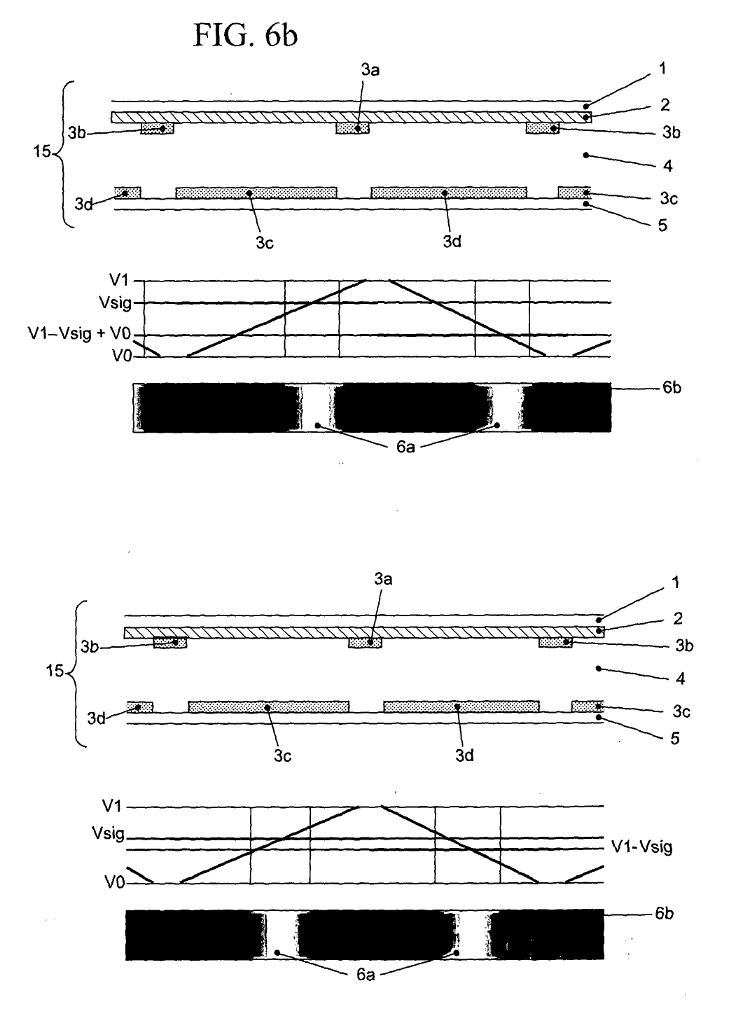

With reference to FIG. 6a and in accordance with a further aspect of the invention, the second substrate may have an additional fourth electrode 3d and the third 3c and fourth 3d electrodes may be patterned into, respectively, an array of third conductive strips and an array of fourth conductive strips, with the third conductive strips being interdigitated with the fourth conductive stripes as in FIG. 6a, with interdigitated strips extending in the first direction. In the cell 15, these strips are positioned between the conducting strips of the first 3a and second 3b electrodes, as shown in FIG. 6b (the righthandmost electrode 3c and the lefthandmost electrode 3d on the lower substrate 5 are not shown in full in FIG. 6b, and if shown in full would have the same width as the other electrodes 3c, 3d on the lower substrate 5). The third electrode 3c is applied with a signal voltage Vsig and the fourth electrode 3d with a voltage (V1−Vsig+V0). This allows the apertures 6a in the array to be evenly spaced, independently of their position between the ramp electrodes 3a, 3b and independently of their width. This barrier is also suitable for head tracked displays, but, like the embodiment described above and in FIG. 4, requires image manipulation (i.e. swapping the left eye and right eye pixel information and shifting the aperture positions) for an extended transverse head freedom.

The optical device 15 may also be used in order to create an array of apertures with constant separation suitable for applications such as 3D autostereoscopic displays, which may provide an extended transverse head freedom without the need for image manipulation such as that described above. This will be exemplified in the following embodiment.

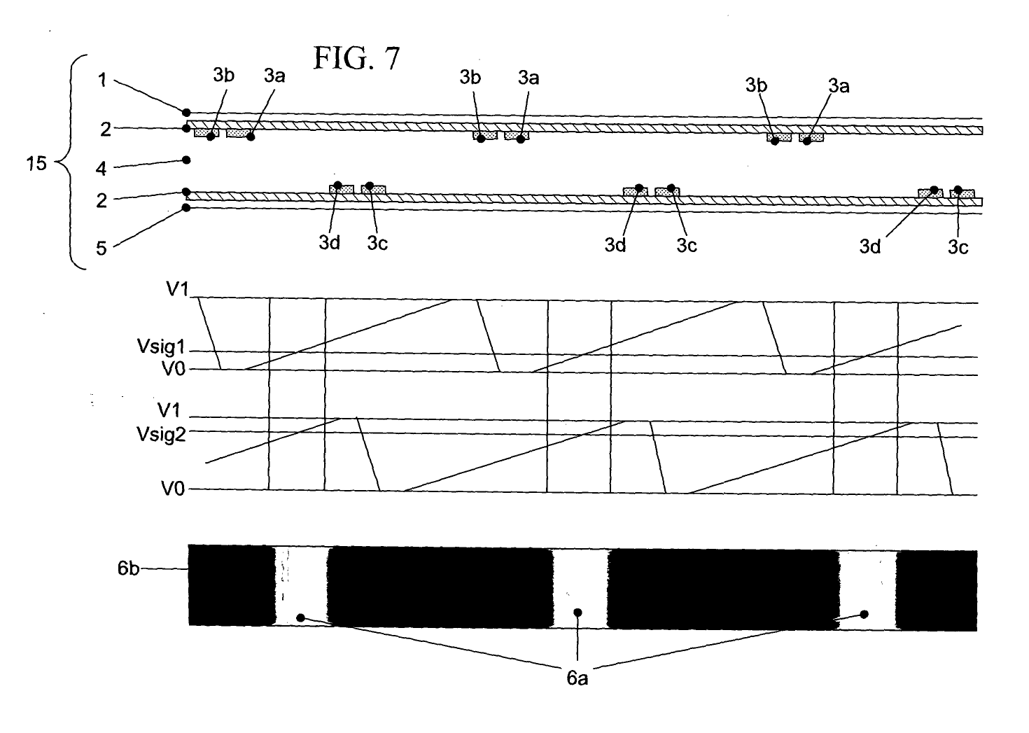

With reference to FIG. 7, a second resistive layer 2 may be provided on the second substrate, so that both the first 1 and second 5 substrates are coated with a resistive layer 2. The third and fourth electrodes 3c, 3d are electrically connected to the second resistive layer disposed on the second substrate 5. The first 3a and second 3b electrodes have unevenly spaced interdigitated conductive strips, as do the third 3c and fourth 3d electrodes, as represented in FIG. 4a. The symmetry of the cell means that there are two possible addressing patterns which may be used to create one barrier pattern (an example is shown in FIG. 7). If the first 3a and second 3b electrodes are addressed with V0 and V1 respectively to create voltage ramps between pairs of conductive strips on the first substrate 1 then the third 3c and fourth 3d electrodes are both addressed with a signal voltage Vsig1. This produces equally spaced apertures. Alternatively, if the third 3c and fourth 3d electrodes are addressed with V0 and V1 to create voltage ramps between pairs of conductive strips on the second 5 substrate then the first 3a and second 3b electrodes may both be addressed with a signal voltage Vsig2 to produce equally spaced apertures in the same positions.

When an aperture approaches a pair of ramp electrodes it will be reaching the end of the voltage ramp. However, by swapping the functionality of the two substrates (ramp electrodes becoming signal electrodes and vice versa, that is moving from the upper addressing scheme shown in FIG. 7 to the lower addressing scheme) the aperture will then be in the middle of a voltage ramp and it will be possible to continue moving the aperture in the same direction. This type of barrier is suitable for tracked displays and permits extended transverse head freedom without the need for a left-right pixel swap or any non-continuous barrier motion. Thus it may offer a higher quality 3D user experience.

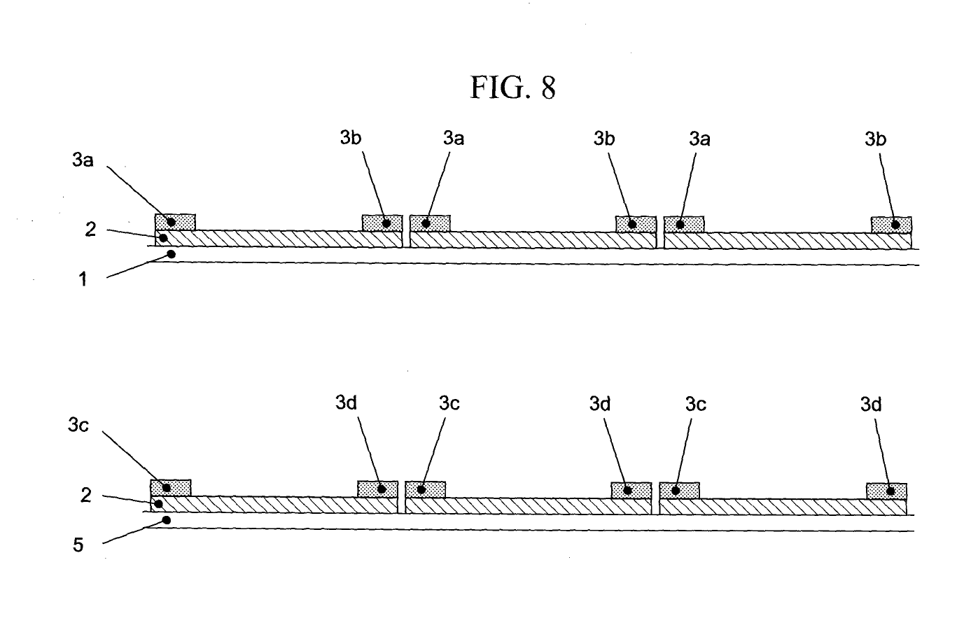

With reference to FIG. 8 and for any of the embodiments described above that use unevenly spaced electrode strips (as exemplified in FIG. 4), the resistive layer 2 on either the first 1 and/or second 5 substrate may be patterned, for example into a plurality of resistive strips that are electrically isolated from one another. This prevents unwanted short circuit, for example between two closely spaced conductive strips, and so ensures the creation of a voltage ramp in the expected positions. Where the resistive layer on the first substrate 1 comprises a plurality of resistive strips, each resistive strip may be electrically connected to a respective conductive strip of the first electrode 3a and a respective conductive strip of the second electrode 3b. Where the resistive layer on the second substrate 5 comprises a plurality of resistive strips, each resistive strip may be electrically connected to a respective conductive strip of the third electrode 3c and a respective conductive strip of the fourth electrode 3d.

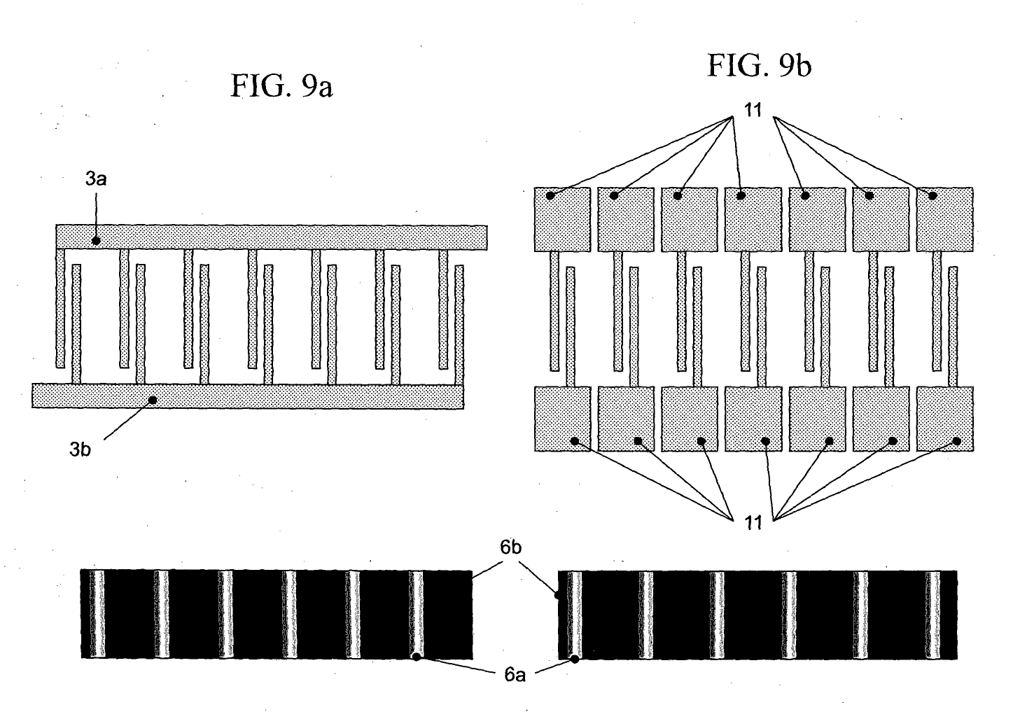

For the embodiments described above the pitch of the aperture array will be equal to the pitch of the electrode array and the width of the apertures will be constant across the barrier (FIG. 9a). This is because there are at most three independent voltage levels: in the above embodiments these were denoted V0, V1 and Vsig, or V0, V1 and Vsig1 or V0, V1 and Vsig2. However, by addressing the electrodes separately or in multiple groups the barrier pitch and aperture width are not subject to these restrictions. Arbitrary aperture separations and widths are possible by the appropriate selection of the ramp and signal voltages.

Thus, in further embodiments of the inventions, one or more of the first, second, third and fourth (if present) electrodes is/are constituted by conductive strips and is/are arranged in two or more groups, each group including at least one conductive strip, and each group of conductive strips being electrically isolated from the or each other group of conductive strips. With reference to the example of FIG. 9b, the first and second electrodes (or the third and fourth electrodes) are constituted by conductive strips arranged in groups, with each group consisting of a single conductive strip to give individually addressable electrodes 11—so that a conductive strip of the first [second] electrode is electrically isolated from each other conductive strip of the first [second] electrode.

Although FIG. 9b shows the conductive strips arranged with each group consisting of a single conductive strip, this embodiment is not limited to this. In further examples (not illustrated) the first and second electrodes (or the third and fourth electrodes) are constituted by conductive strips arranged in groups, with each group consisting of two or more conductive strips.

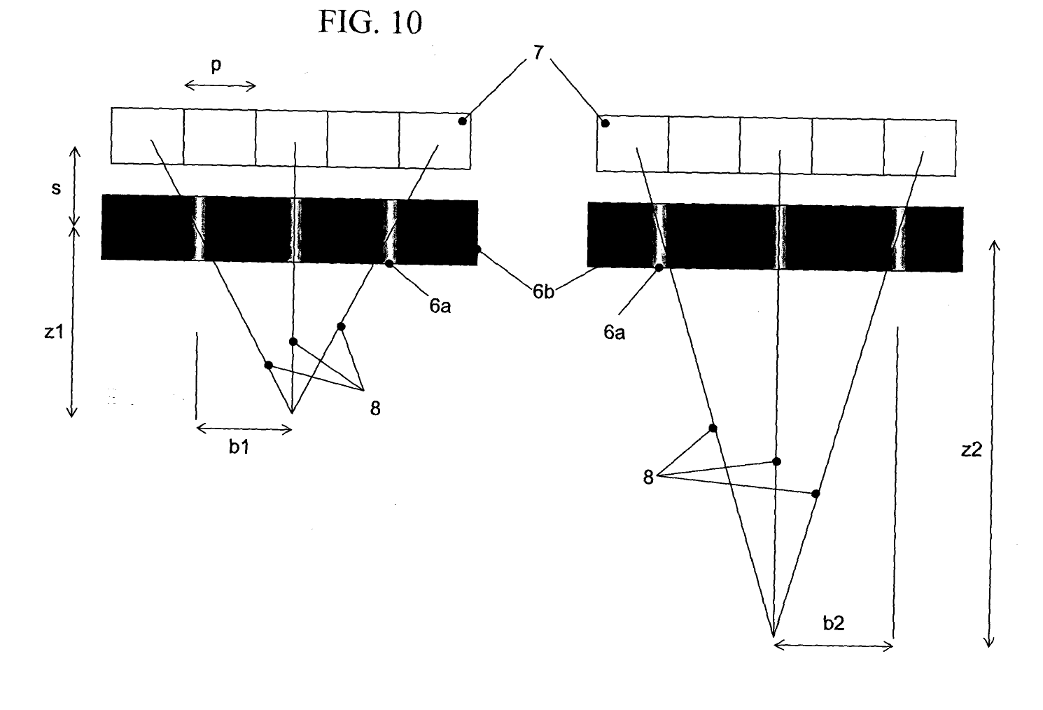

A particular use of barrier pitch control is to produce an array of apertures of constant width across the barrier at constant but arbitrary separation (FIG. 9b) enabling a tracked 3D autostereoscopic display with wide head freedom in the z direction. For example and with reference to FIG. 10, for an interlaced image where the pixels of pitch p alternate between left eye information and right eye information, the required barrier pitch b for a 3D image to be observed correctly at distance z from the screen may be approximated by

$$\frac{b}{z} = \frac{2 p}{z + s \text{/} n} ,$$

where s is the separation in the z direction of the barrier from the pixels and n is the refractive index of the separator material. The lines of gaze 8 from a single eye will fall on alternate pixels on the display screen 7 through the apertures 6a of the barrier. As seen in FIG. 10, at a distance z1 from the barrier, the, required aperture separation b1 for a good 3D image is calculated using the formula above. For a different distance z2 greater than z1, the aperture separation b2 is greater than b1. The aperture separation is a function of the distance of the head from the screen and so the ability to adjust the barrier pitch will improve the head freedom of a tracked 3D display in the z direction.

In order to create a suitable voltage gradient, short circuit must be avoided by the correct selection of material parameters. The conductive electrodes 3a, 3b, 3c, and 3d must have a relatively low resistivity compared to the material that forms the resistive layer 2 so that any voltage along the length of the conducting strips is negligible compared to the voltage drop across the resistive layer 2. The resistivity of the LC layer 4 must be large relative to that of the resistive layer 2 in order that there is no short circuit between the first 1 and second 5 substrates. Typically, the resistivity of the resistive layer 2 may be 6 to 9 orders of magnitude larger than that of the conductor and the resistivity of the LC may be 3 to 5 orders of magnitude larger than that of the resistive layer. A typical LC resistivity for this invention may be IEI3Ω/□, however, the parameters may be altered in order to optimise the invention for barrier uniformity and power consumption.

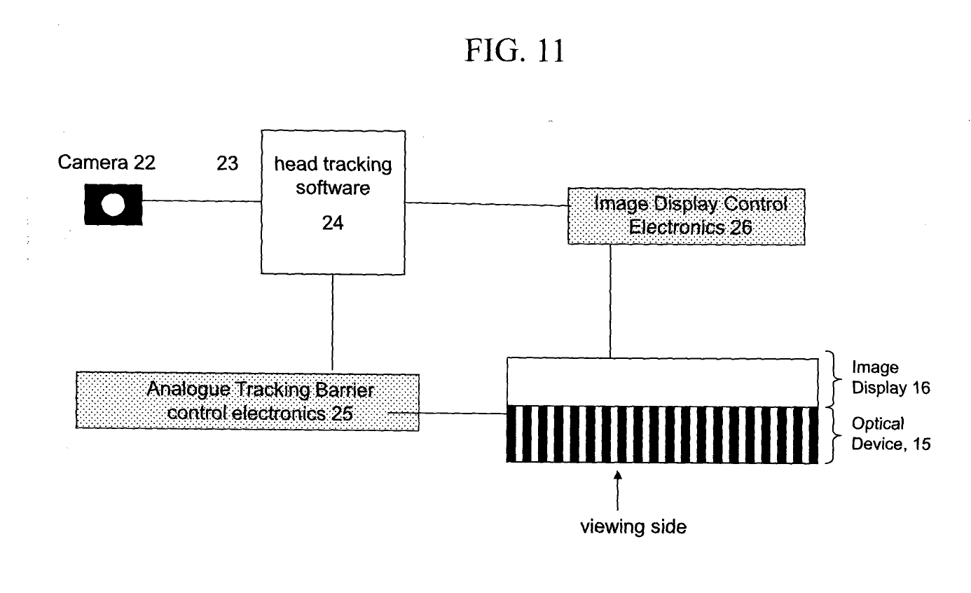

FIG. 11 shows a block diagram of a display system for the use of the invention in a 3D head tracked autostereoscopic display. A display comprises an optical modulation device 15 of the invention disposed in the path of light through an image display layer (provided in the image display 16). The image display is illuminated by a backlight (not shown) in FIG. 11.) A camera 22 connected to a microprocessor 23 with head tracking software 24 installed allows the real world x, y, z coordinates of the eyes of the viewer to be known at any given time. These coordinates are processed with a suitable algorithm to calculate the optimum barrier parameters (aperture pitch and transverse aperture position) and display configurations. This may include the calculation of aperture width as a function of the viewer position in order to correct for any brightness nonuniformities induced by the user moving relative to the barrier. The user may also be able to input parameters such as aperture width directly into the head tracking software 24 to calibrate in accordance with their personal preferences and tolerances.

The optical modulation device 15 has a controller, in the example of FIG. 11 constituted by the analogue tracking barrier control electronics 25. The desired barrier parameters determined by the head tracking software are passed to the controller (eg to the analogue tracking barrier control electronics 25), which then determines suitable values for the first, second and third voltages to be applied to the first, second and third electrodes of the optical modulation device 15 (and, if the optical modulation device also includes a fourth electrode 3d the controller also determines a fourth voltage to be applied to the fourth electrode). For example, the controller (eg the analogue tracking barrier control electronics 25 of FIG. 11) may store pre-calculated sets of values for the first, second and third voltages (and optionally also for the fourth voltage), for example in a look-up table, and may retrieve a set of values for the first, second and third voltages (and optionally also for the fourth voltage) that provide a parallax barrier having the desired barrier parameters. Alternatively, the controller (eg the analogue tracking barrier control electronics 25 of FIG. 11) may calculate sets of values for the first, second and third voltages (and optionally also for the fourth voltage) “on-the-fly” from the received desired barrier parameters. The controller (eg the analogue tracking barrier control electronics 25 of FIG. 11) then applies the determined first, second:and third voltages to, respectively, the first, second and third electrodes of the optical modulation device 15 (and optionally also applies the determined fourth voltage to the fourth electrode) such that a good 3D image is viewed by the user.

FIG. 11 shows the optical modulation device 15 disposed on the viewing side of the display system, that is between the image display 16 and an observer. The invention is not however limited to this, and the optical modulation device may alternatively be disposed between the backlight and the image display 16 such that the image display 16 is on the viewing side of the display system.

The display system of FIG. 11 further includes image display control electronics 26 for driving the image display 16 to display an image in accordance with received image data. The image display control electronics 26 may be conventional, and will not be described further.

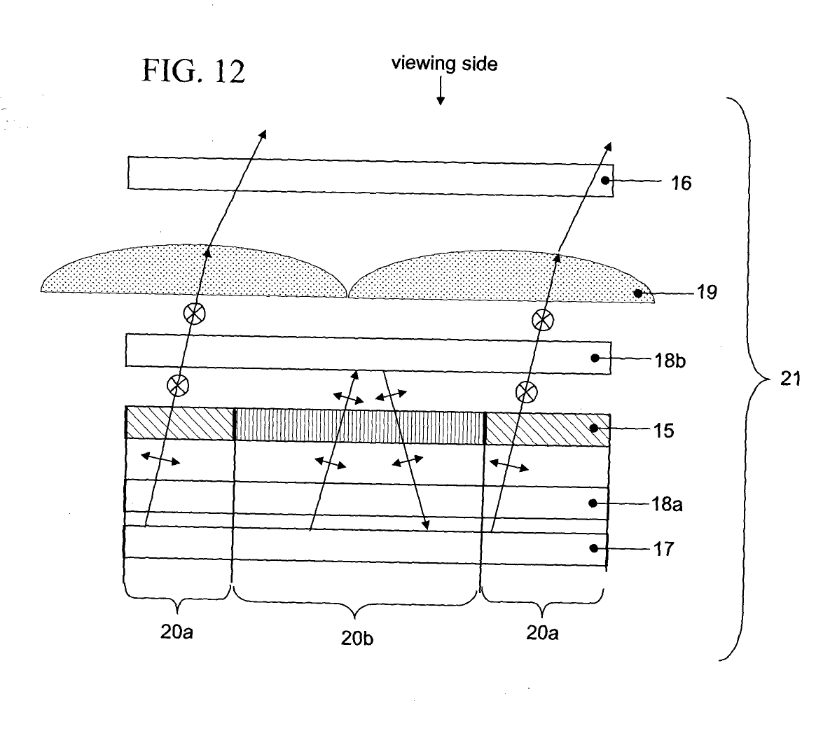

With reference to FIG. 12, the optical device 15 may be used enable a display system 21 that is switchable between a first wide angle viewing mode and a second narrow angle viewing mode. When used in conjunction with a head-tracking system, such as that shown in FIG. 11 for example, the narrow viewing angle mode may be directed towards a user of the display system 21. The narrow viewing mode may be used to reduce the power consumption of the display system 21. Alternatively, or additionally, the narrow viewing mode may be used to by the user for the viewing of private information.

Operation of the display system 21 will now be described. The LCD display device 16 has a backlight 17. Light emanating from the backlight 17 passes through a first reflective polariser 18a, such as a Dual Brightness Enhancement Film (DBEF). Linearly polarised light transmitted by the first reflective polariser 18a is incident on the optical device 15. The optical device 15 may be of the type as shown in FIG. 7. The optical device 15 is switched to produce a first region 20a that rotates the incident plane of polarised light though substantially 90°, and, a second region 20b that does not substantially rotate the plane of polarised light. The light emanating from the optical element 15 is incident on a second reflective polariser 18b, such as a Dual Brightness Enhancement Film (DBEF). The transmission axis of the first reflective polariser 18a is substantially orthogonal to the transmission axis of the second reflective polariser 18b. Light reflected from the second reflective polariser 18b is re-circulated by the backlight 17. Light transmitted by the second reflective polariser 18b is incident upon a lens array 19 which directs through the image display and towards the user. The optical device is arranged so that the distance between the centres of adjacent regions 20a that rotate the plane of polarised light is substantially equal to the distance between the centres of adjacent lenses of the lens array, and so that the alignment in a lateral direction between regions 20a that rotate the plane of polarised light and the centre of the lenses of the lens array results in light that passes through the second reflective polariser 18b being substantially directed towards the observer, resulting in a narrow viewing angle. For example, in the case of an observer viewing the display along the normal direction to the display face, the display would be arranged so that light that passes through the second reflective polariser 18b would pass through the central portions of respective lenses of the lens array, and so would not be substantially deviated by the lens array. The light from the backlight 17 is therefore directed along a narrow range of directions, resulting in a narrow viewing angle.

In a further embodiment transverse movements of the user are detected by a head-tracking system. The head tracking system is operatively coupled to the optical device 15. The optical device 15 is switched such that the positions of the first 20a and second 20b regions are moved appropriately in order that light from the image display 16 is directed substantially towards the user.

To obtain a wide view display mode in the display of FIG. 12, the optical modulation device is switched so that all areas of the optical modulation device rotate the plane of polarisation of light through substantially 90°. Light is then passed by the entire area of the second reflective polariser, and is incident on the entire area of the lens array—and so is directed in a wide range of directions by the lens array, giving a wide viewing angle mode.

### INDUSTRIAL APPLICABILITY

The invention may be used for tracked 3D autostereoscopic displays for improved head freedom both parallel and perpendicular to the screen face.

The invention may also be used for tracked directional displays such as would be desirable for low power applications.

### DESCRIPTION OF REFERENCE NUMERALS

1: First substrate

2: Resistive layer

3(a, b, c, d): Conductive electrode strips (first, second, third, fourth)

4: LC layer

5: Second substrate

6(a, b, c): Barrier appearance (aperture, opaque region, transition region)

7: Display

8(a, b): Lines of gaze (left eye, right eye)

11: Separately addressed electrodes

15: Optical stack forming the invention

16: Display device

17: Backlight

18: Polarisation sensitive reflector

19: Lens array

20: Viewing regions

21: Low power display system

22: camera

23: processor

24: head tracking software

25: controller

26: image display control electronics

1. An optical modulation device comprising an electro-optical cell and a controller, the electro-optical cell having:
a first substrate;
a first electrode and a second electrode disposed on the first substrate, the first electrode being spaced from the second electrode in a direction parallel to the plane of the first substrate;
a resistive layer disposed on the first substrate and electrically connected to the first electrode and to the second electrode;
a second substrate spaced from the first substrate;
a third electrode disposed on the second substrate; and
an electro-optical material disposed between the first substrate and the second substrate;
and the controller being adapted to apply a first voltage to the first electrode, to apply a second voltage to the second electrode and to apply a third voltage to the third electrode, the first, second and third voltages being selected to define at least a first region in the electro-optical cell in which the voltage applied across the electro-optical material is lower than a switching threshold voltage and a second region in the electro-optical cell in which the voltage applied across the electro-optical material is greater than the switching threshold voltage, the third voltage being intermediate the first voltage and the second voltage whereby the position and width of the first region are controllable independently from one another.

2. A device as claimed in claim 1, wherein the first electrode includes an array of first conductive strips and the second electrode includes an array of second conductive strips, the first conductive strips being interdigitated with the second conductive strips.

3. A device as claimed in claim 2 wherein the second conductive strips are unequally spaced between the first strips.

4. A device as claimed in claim 1 and further comprising a fourth electrode disposed on the second substrate, the fourth electrode being spaced from the third electrode in a direction parallel to the plane of the second substrate.

5. A device as claimed in claim 4, wherein the third electrode includes an array of third conductive strips and the fourth electrode includes an array of fourth conductive strips, the third conductive strips being interdigitated with the fourth conductive strips.

6. A device as claimed in claim 4 wherein the device further includes a second resistive layer disposed on the second substrate and electrically connected to the third electrode and to the fourth electrode.

7. A device as claimed in claim 5 wherein the fourth conductive strips are unequally spaced between the third strips.

8. A device as claimed in claim 2 wherein the first resistive layer is a patterned resistive layer comprising a plurality of resistive strips electrically isolated from one another, each resistive strip being electrically connected to a respective first conductive strip and a respective second conductive strip.

9. A device as claimed in claim 5 wherein the second resistive layer is a patterned resistive layer comprising a plurality of resistive strips electrically isolated from one another, each resistive strip being electrically connected to a respective third conductive strip and a respective fourth conductive strip.

10. A device as claimed in claim 2 wherein the first conductive strips are arranged in two or more groups, each group including at least one first conductive strip, and each group of first conductive strips being electrically isolated from the or each other group of first conductive strips.

11. A device as claimed in claim 2 wherein each first conductive strip is electrically isolated from each other first conductive strip.

12. A device as claimed in claim 2 wherein the second conductive strips are arranged in two or more groups, each group including at least one second conductive strip, and each group of second conductive strips being electrically isolated from the or each other group of second conductive strips.

13. A device as claimed in claim 2 wherein each second conductive strip is electrically isolated from each other second conductive strip.

14. A device as claimed in claim 1 wherein the voltage applied across the electro-optical material in the second region is equal to or greater than a saturation voltage.

15. (canceled)

16. A display comprising an image display layer and an optical modulation device as defined in claim 1 disposed in the path of light through the image display layer.

17. A display as claimed in claim 16 wherein the optical modulation device is disposed between the image display layer and an observer.

18. A display as claimed in claim 16 and further comprising a backlight, wherein the optical modulation device is disposed between the backlight and the image display layer.

19. A display as claimed in claim 16 wherein the controller is operable in a first mode to define a parallax barrier aperture array in the optical modulation device and in a second mode different from the first mode.

20. A display as claimed in claim 16 wherein the controller is operable in a first mode to define a first parallax barrier aperture array in the optical modulation device and is operable in a second mode to define a second parallax barrier aperture array in the optical modulation device mode, the second parallax barrier aperture array being different from the first parallax barrier aperture array.

21. A display as claimed in claim 20 wherein the controller receives an input signal from an observer tracking system.
